(19) United States
(12) Patent Application Publication
(10) Pub. No.: US 2011/0146544 A1
(43) Pub. Date: Jun. 23, 2011

(54) METHOD AND SYSTEM FOR SEPARATION OF CONTAMINANTS FROM COAL

(75) Inventors: Isaac Yaniv, Haifa (IL); Ben-Zion Livneh, Denver, CO (US)

(73) Assignee: MICROCOAL INC., City of Wilmington, NewCastle, DE (US)

(21) Appl. No.: 13/002,831

(22) PCT Filed: Jul. 8, 2008
(86) PCT No.: PCT/IL08/00936

§ 371 Date: Jan. 6, 2011

Related U.S. Application Data
(60) Provisional application No. 60/929,949, filed on Jul. 19, 2007.

(51) Int. Cl. B03C 1/30; B03C 1/02; C10L 9/08; F23K 1/04

(52) U.S. Cl. 110/218; 209/214; 209/11; 209/215

(57) ABSTRACT

Provided is a novel method and system to separate magnetically non-susceptible impurities from coal intended for combustion, and it includes the removal of such impurities together with magnetically susceptible impurities that are collocated within the same lump of coal, prior to the combustion of the coal, by the use of the magnetic properties of the magnetically susceptible impurities. The described subject matter is based on the fact that the former impurities are normally collocated in the same lumps of coal as the latter, especially as far as pyrite and cinnabar are concerned, provided the lumps have not been liberated, in particular, they meet the requirement that at least 50% by mass of the coal lumps should be at least 2 mm in maximum dimension.

### FIELD OF THE INVENTION

This invention relates to the field of coal treatment and in particular is concerned with a process and a system to remove contaminants from the coal.

### BACKGROUND OF THE INVENTION

Coal is utilised to fuel over one third of all electric power generation globally, and over half of that in the U.S. Emissions from coal-fired power generation plants include contaminators and environmentally harmful substances. Environmentally, the more significant contaminants in coal are sulfur and mercury derivatives. In the U.S., a restriction on the industrial emission of sulfur was legislated and has been enforced since the 1980's, and in more stringent form since 2000. In addition, new legislation substantially curbing the emission of mercury has been introduced to halve the current emission by 2010, and further reduce it to one-third of current emission by 2018. These restrictions put a major economic burden on the power utilities and greatly increase their operating costs. In the U.S., more than 1 billion tons of coal is consumed annually, over 90% of which is used to generate electricity, the amount of environmentally harmful substances that are released to the atmosphere by the industry is substantial and the removal of these substances from power plants' flue gases before releasing them to the atmosphere becomes a very in intensive engineering focus. The Power Industry has been forced to invest heavily in various means to reduce the emissions of such airborne contaminants to comply with legislative requirements and growing public demands. Furthermore, the presence of some of the coal contaminants creates a problem of forming slag deposits in steam generating boilers, which forces utilities to regularly clean equipment, resulting in a loss of generating capacity, loss of revenue and increased maintenance costs.

The above problems are prevalent in the U.S. in high ranking coals such as Eastern coals, as well as low ranking coals such as the Powder River Basin (PRB) coal. Some 40% of total coal consumed in the U.S.A. is PRB coal due to it being relatively clean and cost effective fossil fuel. Although low in air contaminants, PRB coal suffer from difficulties with other impurities, in particular iron-based compounds which are the main cause for slagging, which offsets its cost benefits. High ranking coals, mainly Eastern coals in the U.S., have naturally much higher levels of contaminants and impurities, which aggravate these problems greately.

Attempts have been made to remove sulfur from coal prior to its combustion, and particularly they were directed to the removal of pyrite which is a sulfuric iron compound. However, these do not seem to have been economically viable. Also, no economically viable means exists for the removal of cinnabar, which is a sulfuric mercury compound, from coal.

The known approach to removing pyrite from coal is by utilizing its weak magnetic attribute, involving two stages namely a liberation stage—which reduces the coal particle size to powder, and a separation stage—to remove the pyrite containing particles from the coal bulk, normally utilizing their weak magnetic properties. Due to the low magnetic susceptibility of pyrite at ambient conditions, high magnetic fields and high magnetic gradients are required to effectively separate the pyrite containing particles from the coal powder. This separation is known as high gradient magnetic separation (HGMS). The liberation as described above normally includes grinding and then milling the raw coal into very fine particles. Desired liberation can effectively be achieved at the particle size of 75 μM, an operation that is energy intensive and costly. Small particle size not only assists with the liberation of pyrite from coal, but also reduces the losses of coal associated with the lumps of pyrite, hence improving the pyrite recovery and yields.

It has been suggested to increase the magnetic susceptibility of pyrite in raw coal by converting it into pyrrhotite by means of microwave irradiation, and conclusions have been made that the smaller the pyrite particles the higher the efficiency of the conversion. In this connection, reference is made to ‘Mossbauer analysis of the microwave desulferization process of raw coal’ by S. Weng (1993); ‘Effect of microwave heating on magnetic separation of pyrite’ by Uslu et all (2003); and ‘Microwave embrittlement and desulpherisation of coal’ by Marland et all (1998).

Apart from high costs and low inefficiency, size reduction of coal to the appropriate particle size causes many problems. Coal has a tendency to spontaneously combust, which increases in likelihood as the particle size of the coal decreases. Coal fines are not only dangerous due to combustion, but also they cause for considerable process losses and require special attention during handling. This is the reason why coal is normally kept in relatively large lumps until very close to its combustion when it is grounded to powder and immediately fed into the boilers.

The traditional magnetic separation process takes place in water-based slurries and is known as wet high intensity magnetic separation (WHIMS). If WHIMS is performed then the coal must be dried subsequent to the WHIMS and prior to combustion, which is energy intensive and with the consequential additional costs.

It has been suggested to use dry magnetic separation of coal fuel prior to its grinding, by means of Magnetic Drum Separators, but this has been found unsuitable for the separation of pyrite from coal due to its low magnetic field and gradients of the drums and due to the lack of sufficient liberation of the pyrite.

The end result of the problematic nature of liberating and removing the pyrite impurity from raw coal is that the process is not normally used. The economic costs of combusting coal containing pyrite as an impurity are considered as the necessary evil, and are normally added to the operating costs of power utilities.

It is known in the industry to deploy desulfurization processes in early stages of the coal value chain, closely after mining, by means of gravity separation, or much later after the coal combustion by treating the boiler flue gasses and removing the sulfur components from these gases.

Currently there are no known cost effective processes employed to remove non-magnetically susceptible contaminants such as cinnabar, which is a sulfuric mercury compound, from coal prior to its combustion for electricity generation. Mercury is typically removed by treating the flue gases after combustion and prior to their release to the atmosphere. Methods utilized include flue gas desulfurization, and selective catalytic reduction.

### SUMMARY OF THE INVENTION

This invention is directed to a novel method and system to separate magnetically non-susceptible impurities from coal intended for combustion, and it includes the removal of such impurities together with magnetically susceptible impurities that are collocated within the same lump of coal, prior to the combustion of the coal, by the use of the magnetic properties of the magnetically susceptible impurities. The invention is based on the fact that the former impurities are normally collocated in the same lumps of coal as the latter, especially as far as pyrite and cinnabar are concerned, provided the lumps have not been liberated, in particular, they meet the requirement that at least 50% by mass of the coal lumps should be at least 2 mm in maximum dimension.

The coal lumps including a pre-determined level of the magnetically susceptible impurities along with the magnetically non-susceptible impurities may be separated, prior to combustion, from those in which the magnetically susceptible impurities is below the above level, by either magneto-metric sorting or by magnetic separation. The former technology is based on the detection of magnetic properties of the coal lumps and sorting of the coal lumps, mechanically or by other means, based on the detection results. This may be performed either close to coal extraction site or anywhere else. The latter technology is based on the dry magnetic separation of the kind discussed in the Background of the Invention, and is preferably to be performed at or close to the combustion facility.

The magnetic properties of the magnetically susceptible impurities and consequently of the coal lumps may be enhanced by heat treatment of the coal. In particular, by such treatment pyrite which is a weak paramagnetic substance may be converted into pyrrhotite, a strong ferromagnetic material, so that the lumps of coal containing both the magnetically susceptible pyrrhotite and magnetically non-susceptible cinnabar may now be removed together utilizing the low intensity dry magnetic separation processes, for example magnetic drum separation, which are cheaper and simpler to operate than WHIMS.

The heat treatment process may result in both the conversion of the pyrite to pyrrhotite in the coal lumps, and at least partial drying of the coal lumps. In case, when the heat treatment is performed by means of electromagnetic radiation, the treatment may require a short time period, for example less than 20 minutes.

The application of the magnetic separation process may form part of a total energy management in a power generation market, such as that described in PCT patent application No. PCT/IL2004/001077, which is enclosed herewith and is, in its entirety, incorporated herein by reference, where it is suggested to use electromagnetic radiation for upgrading coal by its drying to reduce inherent moisture content in the coal, and this during periods of low demand in consumption of electric power. Due to this, additional benefits may be provided in that the electric power required to provide both the enhancement of the magnetic properties of pyrite and drying the coal is obtained by making use of the slack generation capacity during low demand periods.

The system of the present invention comprises coal supply station to supply coal lumps of which at least 50% by mass of the coal lumps must be at least 2 mm in maximum dimension; and a separator station to receive said coal lumps at least indirectly from said coal supply station and to separate those lumps of coal having magnetic properties above a predetermined limit.

In one particular embodiment, the system of the present invention may be designed to separate coal lumps having pre-determined amount of pyrite contaminant and also having cinnabar contaminant, and it includes:
a) a coal supply station to supply coal lumps of which at least 50% by mass of the coal lumps must be at least 2 mm in maximum dimension;
b) an optional magnetic properties enhancement station to convert pyrite in said coal lumps into pyrrhotite;
c) a separator station to separate those of said lumps of coal, which have magnetic properties above a predetermined limit corresponding to said pre-determined amount of pyrite;
d) a discard station to receive the separated coal lumps.

The system may constitute a part of power generation plant, which further includes a combustion station to burn the lumps of coal left after the separation of coal having magnetic properties above said predetermined limit.

### BRIEF DESCRIPTION OF THE DRAWINGS

In order to understand the invention and to see how it may be carried out in practice, a number of embodiments will now be described, by way of non-limiting examples only, with reference to the accompanying drawings, in which:

FIG. 1 is a flow chart of a system in accordance one embodiment of the invention;

FIG. 2 is a flow chart of a system in accordance with another embodiment of the invention;

FIG. 3 is a flow chart of a system in accordance with a further embodiment of the invention; and

FIG. 4 is a flow chart of a system in accordance with a still further embodiment of the invention.

### DETAILED DESCRIPTION OF EXEMPLARY EMBODIMENTS

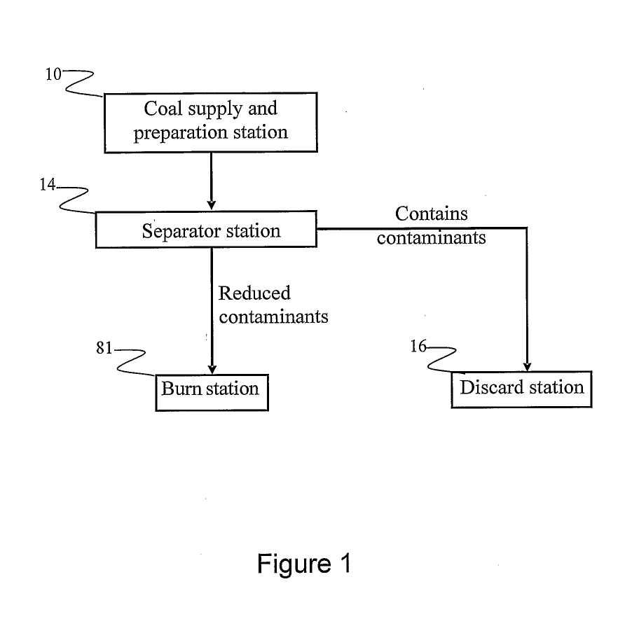

FIGS. 1 to 3 show several non-limiting examples of a system according to different embodiments of the present invention for use with raw and/or treated coal including, but not limited to PRB coal, containing sulfuric iron compound impurities such as pyrite, and sulfuric mercury compound such as cinnabar, intended for combustion, the system being designed for the separation from the coal a part of the pyrite and the cinnabar, prior to the combustion, by rejecting those coal lumps where the amount of pyrite is above a predetermined level. The system constitutes a part of a power generation plant, where the coal is to be burnt.

In the embodiments of FIGS. 1 to 3, the system comprises a coal supply and preparation station 10, a separator station 14, and a discard station 16, and it is shown in the Figures in combination with a burn station 18 which may have a storage facility, permanent, semi-permanent or transitory.

The coal preparation and supply station 10 is designed to prepare and supply to the system coal lumps of which at least 50% by mass are over 2 mm, in particular over 10 mm, in their largest dimension. This station may include a crushing sub-station to crush the coal to the described dimensions and a supply sub-station to supply the crushed coal to the separator station 14. It should be noted that the crushing sub-station does not need to be located at the electricity generation plant, in which case the coal supply sub-station may only be needed to supply the crushed coal to the separator station 14. It should also be noted that the crushing sub-station may be part of the existing electricity generation plant processes which may be used to supply the crushed coal to the separator station 14.

The separator station 14 is designed to separate those of the lumps of coal, which have magnetic properties above a predetermined limit corresponding to the pre-determined amount of pyrite or to the amount of selected heat, in particular but not limited to, EMR, that the lumps of coal are subjected to.

The discard station 16 is capable to receive the separated coal lumps.

In operation, coal lumps of the dimensions indicated above are supplied from the coal supply and preparation station 10 to the separator station 14 which separates by means of mechanical separation and/or magnetic separation apparatus the coal lumps magnetic properties corresponding to the predetermined limit mentioned above.

The coal lumps separated by the separator station 14 are then transported to the discard station 16, whilst the remainder of the coal lumps is transported to the burn station 18. The coal lumps are transported between the stations by means adapted for the purpose. The coal lumps may be stored at any stage during the process.

FIG. 1 shows an example where the system comprises only the stations described above.

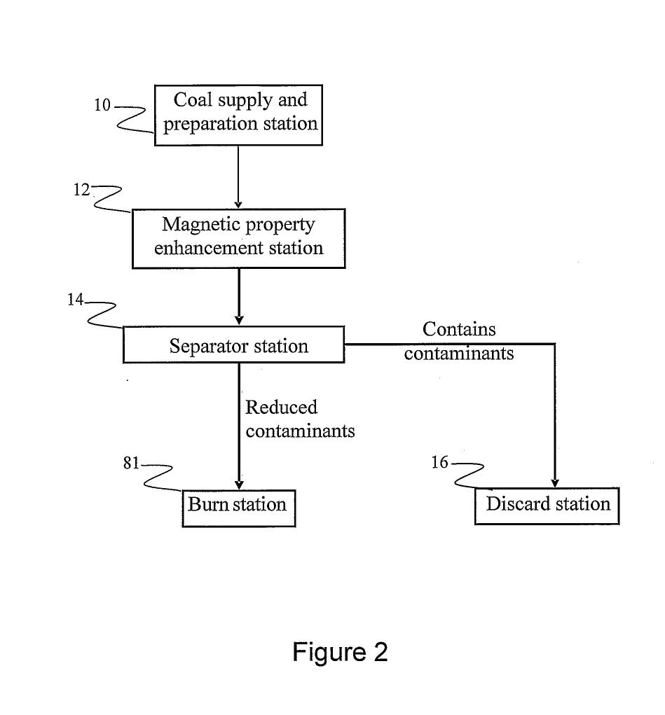

FIG. 2 shows a system which comprises, in addition the coal supply and preparation station 10, the separator station 14, and the discard station 16, a magnetic property enhancement station 12, to increase magnetic susceptibility of the contaminated coal lumps.

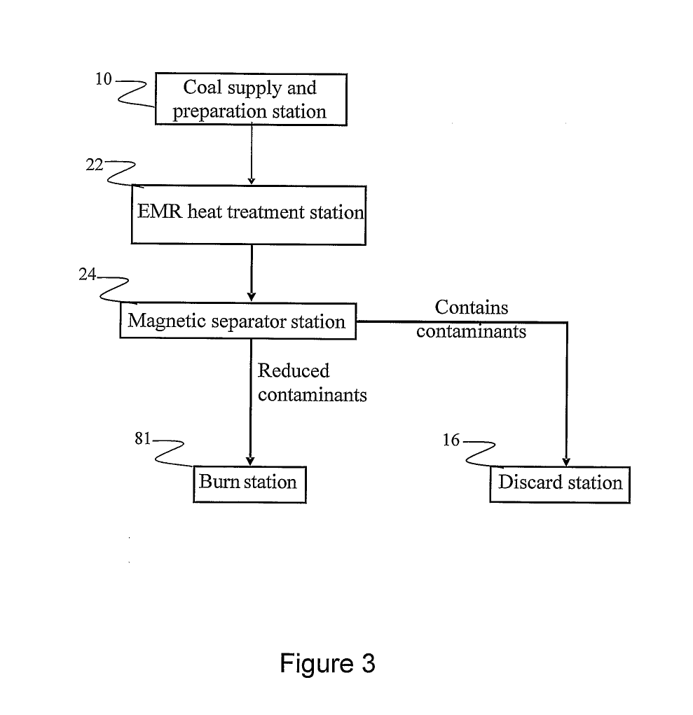

FIG. 3 shows a system similar to that shown in FIG. 2, where the magnetic property enhancement station is in the form of an electromagnetic radiation (EMR) heat treatment station 22, the separator station is in the form of a magnetic separator 24, such as e.g. a magnetic drum separator.

In operation, the EMR heat treatment station 22 heats the coal, for example utilising an infrared heater or microwave oven, converting pyrite in to pyrrhotite, taking a short period of time, for example 20 minutes, the degree of conversion being dependant upon heat, energy and time factors. The coal is then transported to the magnetic separator 24, which utilizes the magnetic susceptibility of the impurities to separate out the lumps that contain pyrrhotite above the predetermined level.

The system in accordance with the present embodiment may constitute a part, or its components may be incorporated in or combined with those, of the system described in the enclosed PCT patent application No. PCT/IL2004/001077, whose ‘Detailed Description’ together with FIG. 1 is incorporated herein by reference. In this case, the coal supply and preparation station 10 may be combined with, form a part of, or be constituted by, loading station 16 in the system shown in FIG. 1 of the PCT application, the EMR heat treatment station 22 may be combined with, or form a part of, or be constituted by, MW drying plant 20 in the system shown in FIG. 1 of the PCT patent application, which may also incorporate therein the magnetic separator station 24. Since as indicated in the PCT application, the MW drying plant may include a plurality of stages, the EMR heat treatment station 22, together with its magnetic separator 24, may form a part of such stages, whereby it may be ensured that final stage(s) of the coal upgrading are performed only on those coal lumps which remained after the magnetic separation process.

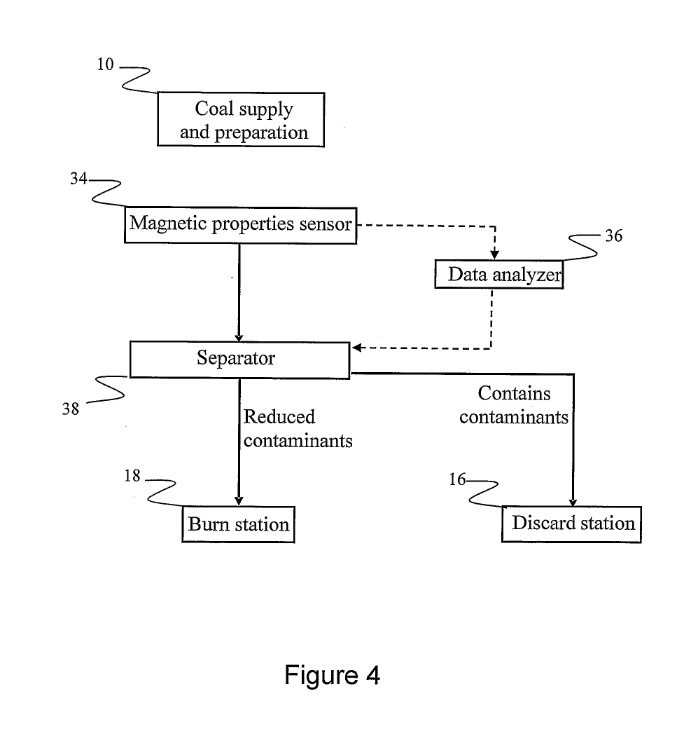

FIG. 4 shows a system similar to that shown in FIG. 1, which includes, instead of the separator station 14, magnetic properties sensor 34, a data analyzer 36 and a sorter 38.

In operation, the magnetic properties sensor 34 measures the magnetic properties of the coal, the magnetic properties data is analyzed by the data analyzer 36. The sorter 38 utilizes the data from the data analyzer 36 to determine where to direct the coal lumps, either to the burn station 18 or the discard station 16.

Although a description of a specific embodiment has been presented, it is contemplated that various changes could be made without deviating from the scope of the present invention.

1-19. (canceled)

20. A method of separating from raw and/or treated coal including magnetically non-susceptible impurities along with magnetically susceptible impurities and intended for combustion, at least a part of said magnetically non-susceptible impurities, the method comprising:
providing said coal in the form of coal lumps of such dimension that the magnetically susceptible and non-susceptible impurities are collocated within the same lumps, and
magnetically separating from the coal, prior to said combustion, those lumps which are magnetically susceptible beyond a predetermined level.

21. The method according to claim 20, further comprising enhancement of magnetic properties of said magnetically susceptible impurities.

22. The method according to claim 20, wherein the lumps of said coal are at least 50% by mass over 2 mm in their maximum dimension.

23. The method according to claim 20, wherein at least one of said magnetically susceptible impurities is sulfuric iron compound and at least one of said magnetically non-susceptible impurities is cinnabar, said predetermined level being defined by a predetermined amount of sulfuric iron compound in the coal lumps.

24. The method according to claim 21, wherein said enhancement is performed by heat treatment.

25. The method according to claim 24, wherein said heat treatment is performed by electromagnetic radiation.

26. The method according to claim 24, wherein said heat treatment reduces the water content of said coal.

27. A method according to claim 20, constituting a part of a power generation process including said combustion.

28. A system for the separation from raw and/or treated coal including magnetically non-susceptible impurities along with magnetically susceptible impurities and intended for combustion, at least a part of said magnetically non-susceptible impurities, the system comprising:
a coal supply station to supply said coal in the form of coal lumps of such dimension that the magnetically susceptible and non-susceptible impurities are collocated within the same lumps; and
a separator station to receive said coal lumps at least indirectly from said coal supply station and to separate from the coal those lumps which are magnetically susceptible beyond a predetermined level.

29. The system according to claim 28, wherein said supply station is adapted for the supply of the lumps of said coal being at least 50% by mass over 2 mm in their maximum dimension.

30. The system according to claim 28, wherein said separator station is adapted to separate from the coal those lumps which are magnetically susceptible beyond a predetermined level, the level corresponding to a predetermined amount of sulfuric iron compound in the coal lumps.

31. The system according to claim 28, further comprising a magnetic properties enhancement station for the enhancement of magnetic properties of said magnetically susceptible impurities.

32. The system according to claim 31, wherein said enhancement station is a heat treatment station.

33. The system according to claim 32, wherein said heat treatment station is an electromagnetic radiation heat treatment station.

34. The system according to claim 32, wherein said heat treatment station is adapted for drying the coal to reduce the water content therein.

35. A system according to claim 28, constituting a part of power generation plant.

36. The method according to claim 20, wherein said coal is a low rank coal.

37. A method according to claim 20, being a part of the method for managing generated electric power in an electric power market where consumption of electric power exhibits periods of different demands, the method comprising:
upgrading solid fossil fuel by EMR drying during periods of low demand using said electric power; and
utilizing said upgraded solid fossil fuel.

38. A system according to claim 28, being a part of the system for energy production by burning solid fossil fuel in a power generation plant including burners, the system comprising:
an EMR drying plant for upgrading said solid fossil fuel, adapted to reduce inherent moisture content in the upgraded solid fossil fuel by 50% or more; and
transportation means for moving the upgraded solid fossil to said burners.
